(19) United States
(12) Patent Application Publication
(10) Pub. No.: US 2021/0124130 A1
(43) Pub. Date: Apr. 29, 2021

(54) ANGLE POLISHED FIBER OPTIC CONNECTIONS

(71) Applicant: Senko Advanced Components, Inc., Marlborough, MA (US)

(72) Inventor: Heng Loong LEE, Puchong (MY)

(73) Assignee: Senko Advanced Components, Inc., Marlborough, MA (US)

(21) Appl. No.: 17/084,105

(22) Filed: Oct. 29, 2020

Related U.S. Application Data
(60) Provisional application No. 62/927,648, filed on Oct. 29, 2019.

(51) Int. Cl. G02B 6/38

(52) U.S. Cl. CPC G02B 6/3829; G02B 6/3863; G02B 6/383

(57) ABSTRACT

An angle polished fiber optic connector adapted for connection with another angle polished connector in two, reversed configurations has a connector body and first and second angle polished ferrules. The first ferrule is supported by the connector body in a first fixed rotational position about the longitudinal axis of the first ferrule, and the second ferrule is supported by the connector body in a second fixed rotational position about the longitudinal axis of the second ferrule. The second fixed rotational position of the second ferrule being offset by 180 degrees from the first fixed rotational position of the first ferrule. A method of making an angled polished fiber optic connector that can be connected with different polarities is also disclosed.

### CROSS-REFERENCE TO RELATED APPLICATION

This application claims priority to U.S. Provisional App. No. 62/927,648, filed Oct. 29, 2019, the entirety of which is hereby incorporated by reference.

### FIELD

The present disclosure generally relates to fiber optic connections, and, more specifically, to an angle polished fiber optic connector and connection systems.

### BACKGROUND

Optical connectors are used within optical communication networks to interconnect optical cables to optical devices or other optical cables. Optical connections typically involve two optical connectors connected together. These optical connectors typically include housings that mate with one another to form the optical connection. In the field, there are different, commonly used connections for fiber optic connectors. In some instances, the ends of fiber optic ferrules used to make optical connections and angle polished. The end faces of the ferrules that mate are polished so that they make an angle with respect to the longitudinal axis of the ferrule. The mating ferrules engage each other along an angled surface. This helps to reduce back reflection of light passing across the interface between the mating ferrules. Reflected light exits the fiber rather than being reflected back into the fiber.

### SUMMARY

In one aspect, an angle polished fiber optic connector adapted for connection with another angle polished connector in two, reversed configurations generally comprises a connector body, a first ferrule and a second ferrule. The first ferrule has a longitudinal axis extending lengthwise of the first ferrule, and includes a first fiber. The first ferrule has a connection end face that is polished at an angle from perpendicular to the longitudinal axis of the first ferrule and is supported by the connector body in a first fixed rotational position about the longitudinal axis of the first ferrule. A second ferrule has a longitudinal axis extending lengthwise of the second ferrule, and includes a second fiber. The second ferrule having a connection end face that is polished at an angle from perpendicular to the longitudinal axis of the second ferrule. The second ferrule is supported by the connector body in a second fixed rotational position about the longitudinal axis of the second ferrule. The second fixed rotational position of the second ferrule is offset by 180 degrees from the first fixed rotational position of the first ferrule.

In another aspect of the present invention, a method of making an angled polished fiber optic connector generally comprises polishing end faces of fiber optic ferrules at the same angle. At least one of the ferrules is manipulated so that as installed in a connector body the positions of the end faces are 180 degrees opposite from each other.

Other objects and features of the present disclosure will be in part apparent and in part pointed out hereinafter.

### BRIEF DESCRIPTION OF THE DRAWINGS

FIG. 1(A) is a schematic front view of two, mating connectors of the CS type having angle polished ferrules;

FIG. 1(B) is a schematic front view of two, mating connectors of the SN type having angle polished ferrules;

FIG. 2 is a perspective of two sets of mating CS type connector pairs of the angle polished connectors positioned for mating;

FIG. 3 is an enlarged, fragment of the perspective of FIG. 2 showing angle polished ferrules;

FIG. 4 is a perspective of two sets of mating SN type connector pairs of the angle polished connectors positioned for mating; and

FIG. 5 is an enlarged fragment of the perspective of FIG. 4 showing angle polished ferrules.

Corresponding reference characters indicate corresponding parts throughout the drawings.

### DETAILED DESCRIPTION

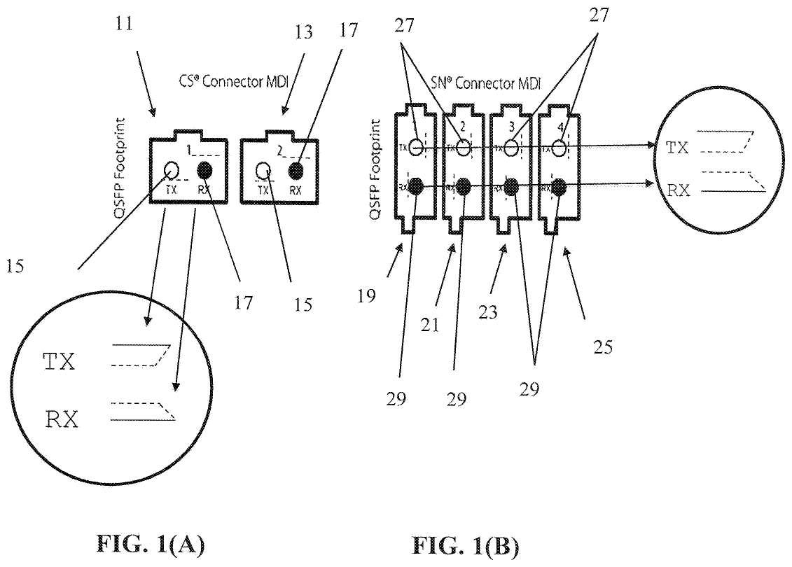

Referring to FIG. 1(A), a pair of fiber optic, duplex receptacles 11, 13 are shown to be sized to be contained within a quad small form pluggable (QSFP) footprint, which is shown as a shaded rectangle in FIG. 1(A). Each receptacle 11, 13 includes a first angle polished ferrule 15 and a second angle polished ferrule 17. As may be seen in side view of the ferrules 15, 17 depicted in the bubble below FIG. 1(A), the first ferrule 11 (also labeled TX) of the receptacle 11 is angle polished so that an end face of the ferrule is directed slightly downward. In the illustrated embodiment, the first angle polished ferrule 15 is for the transmission optical signal. The second ferrule 17 (also labeled RX) of the receptacle 11 is angled polished so that its end face is directed slightly upward. The part of the ferrule 15, 17 cut to an angle by the polish is shown in dashed lines in the bubble. The position of the end faces of the first and second ferrules 15, 17 in the receptacles 11, 13 is indicated by dashed lines either under or above the ferrule. Thus for example, the first ferrule 15 in the receptacle 13 is positioned so that the end face is directed slightly downward, and the second ferrule 17 in the receptacle 13 is positioned so that the end face is directed slightly upward. Therefore, the dashed line for the first ferrule 15 is below the ferrule, and the dashed line for the second ferrule 17 is above the ferrule. This pattern of indicating orientation of the angle polished ferrules is carried forward throughout the views of FIGS. 1(A) and 1(B). The orientation of the first angle polished ferrules 15 in each of the receptacles 11, 13 is arranged 180° from the orientation of the second angle polished ferrule 17 in the other receptacle. Duplex fiber optic connectors (not shown) that mate with the receptacles 11, 13 have angle polished ferrules arranged oppositely to the arrangement of the ferrules 15, 17 in the receptacles.

FIG. 1(B) shows four SN type duplex receptacles (designated 19, 21, 23 and 25, respectively) that are sized to be contained within a quad small form pluggable (QSFP) footprint, which is shown as a shaded rectangle in FIG. 1(B). Each receptacle 19, 21, 23, 25 includes a first angle polished ferrule 27 and a second angle polished ferrule 29. As may be seen in the top view of the ferrules depicted in the bubble to the right of FIG. 1B, the first ferrule 27 (also labeled TX) is angle polished that its end face is directed slightly to the left. In the illustrated embodiment, the first angle polished ferrule 27 is for the transmission optical signal. The second ferrule 29 (also labeled RX) is angled polished so that its end face is directed slightly to the right. The part of the ferrule 27, 29 cut back by the polish is shown in dashed lines in the bubble. The position of the end faces of the first and second ferrules 27, 29 in the receptacles 19, 21, 23, 25 is indicated by dashed lines either to one side or the other of the ferrule. Thus, it will be understood that the rotational orientation of the ferrules 27, 29 is different from the ferrules 11, 13 of FIG. 1(A). The angled end faces of the ferrules 27, 29 are positioned to face to the left or to the right, rather than up or down. However, as with the CS type receptacles of FIG. 1(A) for each receptacle 19, 21, 23, 29, the ferrules 27, 29 are arranged so that the end faces are arranged 180° opposite to each other. Moreover as shown in FIG. 1(B), the orientation of the ferrules 27, 29 in the first receptacle 19 are opposite to the orientation of the ferrules 27, 29 in the second receptacle 21. The third receptacle 23 has arrangement of ferrules 27, 29 identical to the first receptacle 19 and the fourth receptacle 25 has an arrangement of ferrules 27, 29 identical to the second receptacle 21. Other combinations of receptacles are possible.

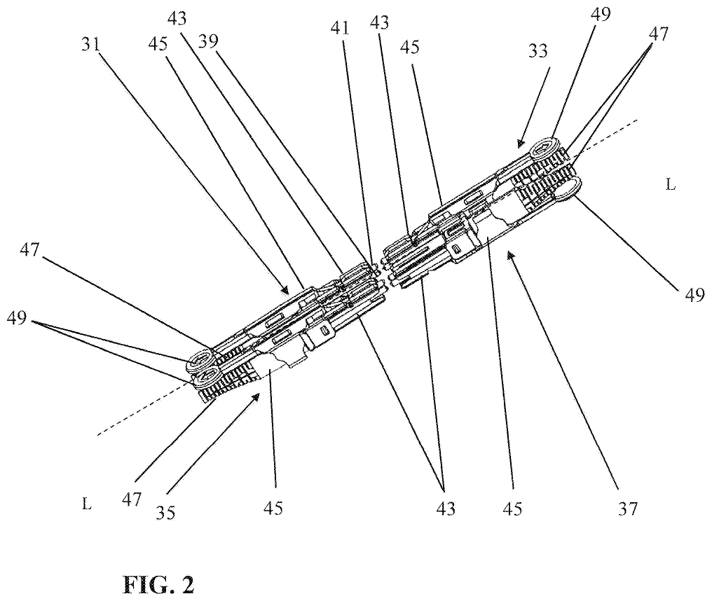

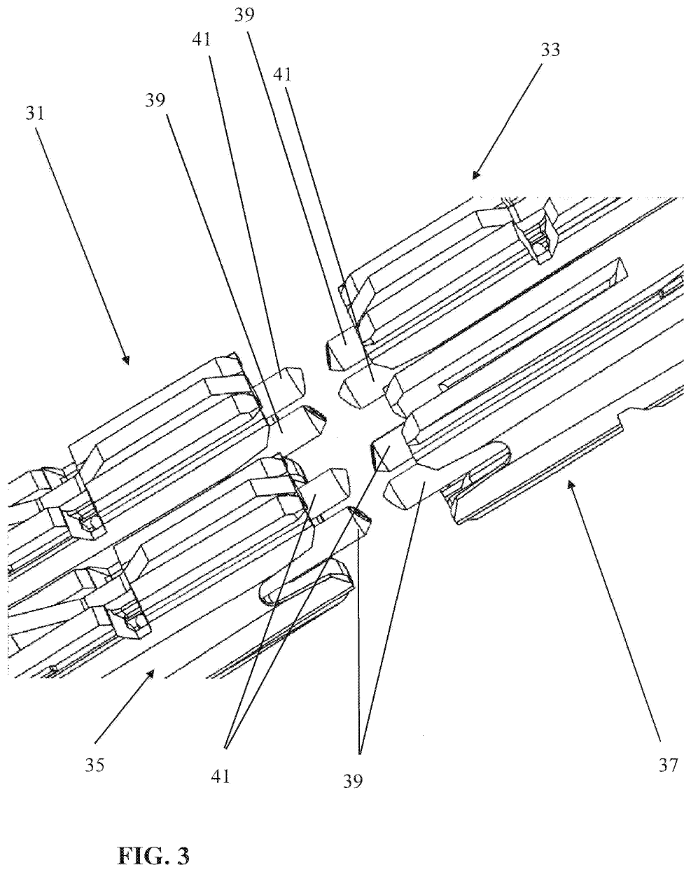

Referring now to FIGS. 2 and 3, two mating pairs of CS type fiber optic connectors (designated 31, 33, 35, and 37, respectively) are shown in position along a longitudinal axis L-L for mating to make an optical connection. If the connectors 31, 33, 35, 27 were actually being mated, there would be an adapter (not shown) between them. However as illustrated in FIGS. 2 and 3, it is possible to better observe the arrangement of the angle polished ferrules 39, 41 of each connector 31, 33, 35, 37. The connectors can be of any suitable construction. As shown, each connector (31, 33, 35, 37) comprises (in addition to the angle polished ferrules 39, 41) a front body 43 supporting the ferrules, a back body 45 connected to the front body and a strain relief boot 47. In addition, each connector 31, 33, 35, 37 includes a latching mechanism including a pull tab 49. The latching mechanism is used to connect each of the connectors 31, 33, 35, 37 to the adapter and the pull tab can be used to release the connection. It will be understood that the connectors 31, 33, 35 and 37 may have other constructions within the scope of the present invention. Co-assigned U.S. Pat. No. 10,185,100 disclosing a CS connector is hereby incorporated in its entirety by reference.

As discussed above, a feature of the present invention is the rotational orientation of the angle polished ferrules 39, 41 in each connector 31, 33, 35, 37. For each connector, one of the ferrules 39 is oriented so that the angled end face is directed generally upward, and the other of the ferrules 41 is oriented so that the angled end face is directed generally downward. Again, the rotational orientation of the ferrules 39, 41 are 180° opposite each other. As may be seen in FIG. 3, the connectors 31 and 33 are positioned in line for connection to each other. Each connector 31, 33 has its ferrules 39, 41 oriented in the same way. When the two connectors are positioned for connection as shown, it may be seen that the ferrule 39 of the connector 31 having an upwardly directed end face opposes the ferrule 41 of the connector 33 having a downwardly directed end face. As a result, when the ferrules are brought into engagement, the upwardly directed end faces of the ferrules 39 will engage the downwardly directed end faces of the ferrules 41 for a generally flush connection which is best for the passage of light travelling along the fibers in the ferrules through the junction of the ferrules. Stated another way, the angles of the end faces of the mating ferrules 39, 41 measured from a longitudinal axis of the ferrules supplement each other.

The arrangement of the connectors 35 and 37 for connection illustrates the functionality of the opposite rotational orientation of the ferrules 39, 41 in the connectors. The ferrule 35 is in the same, “upright” position as the connectors 31 and 33. However, the connector 37 has been turned upside down so that the position of the ferrules 39, 41 is reversed from the position in the adjacent connector 33. This can be referred to as changing the polarity of the connector 37. As a result, instead of the ferrule 39 of the connector 35 being positioned to mate with the ferrule 41 of the connector 37, the ferrule 39 of the connector 35 is positioned to mate with the ferrule 39 of the inverted connector 37. Never-the-less, the ferrule 39 of the connector 37 is oriented so that its end face is positioned for flush engagement with the end face of the ferrule 39 of the connector 35. It will be understood that rotation of the connector 37 from its upright position to the upside down position has the effect of reversing the position of angle polished end face of the ferrule 39 from facing generally upwardly to facing generally downwardly. As a result, the end face of the ferrule 39 of the connector 37 is positioned at an angle to supplement the angle of the end face of the ferrule 39 of the connector 35. Therefore, reversing the polarity of any of the connectors 31, 33, 35, 37 will have no effect on the ability of the end faces of the ferrules 39, 41 to make flush engagement.

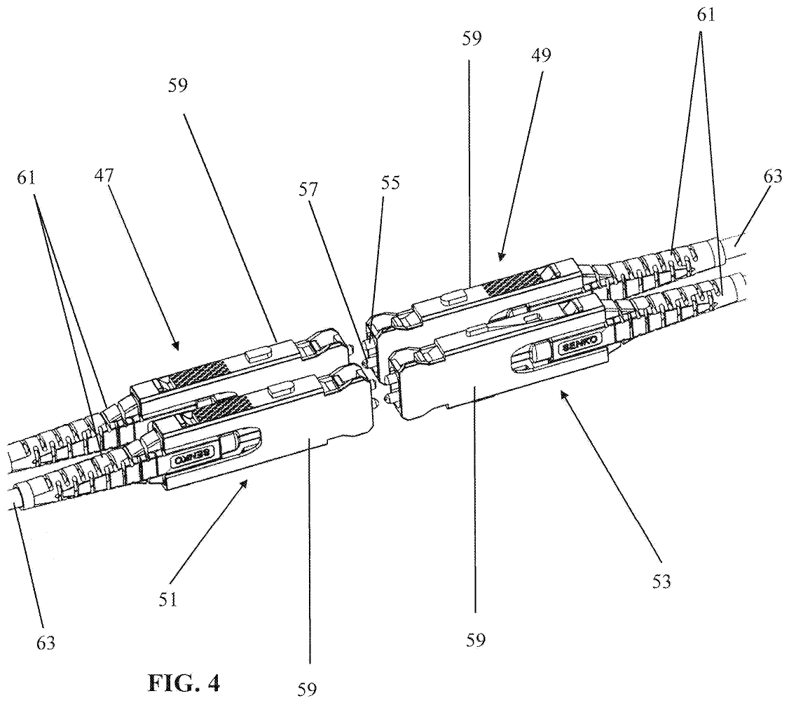

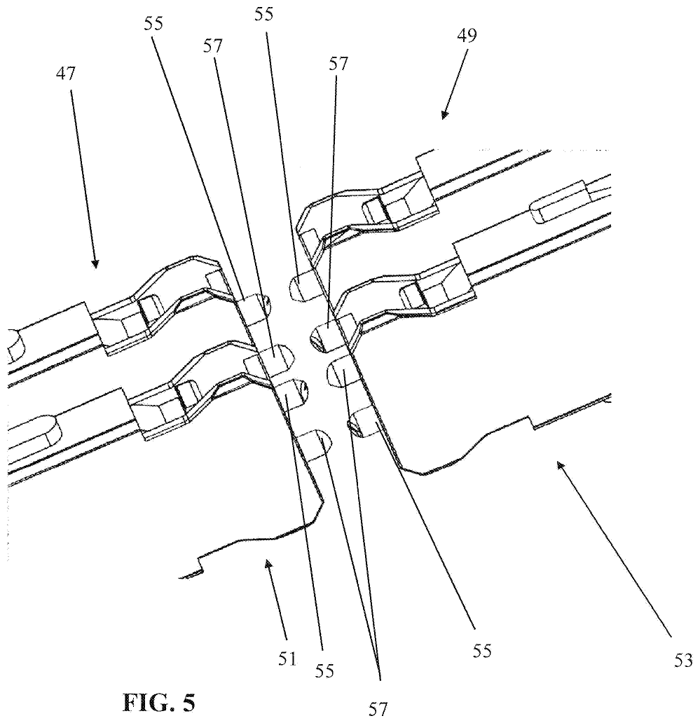

Referring now to FIGS. 4 and 5, it will be seen that the SN type connectors 47, 49, 51, 53 have the same ability to reverse polarity while achieving a flush engagement of angle polished end faces of ferrules 55, 57. The SN type connectors 47, 49, 51, 53 include a connector housing 59 (broadly, a “connector body”) and a strain relief boot 61. FIG. 4 shows cables 63 (only two of which may be seen) attached to the boots 61. The connector housings 59 are constructed to receive components of a latching mechanism used with an adapter (not shown) that accomplishes a mechanical connection of the mating connectors 47 and 49, and 51 and 53, respectively. As described above in regard to ferrules 27, 29 of the receptacles 19, 21, 23, 25, the orientation of the ferrules 55, 57 in each connector 47, 49, 51, 53 are such that in an “upright” position, the angled end face of the ferrule 55 is directed to the left and the angled end face of the ferrule 57 is directed to the right (from a vantage looking toward the end of the connector). Thus, when two upright connectors 47 and 49 are brought into engagement (see, FIG. 5), the angled end faces of the mating ferrules 55,55 and 57, 57, respectively, are supplementary and will have a flush engagement for the best transmission of the light signal through the junction. Similar to the arrangement of the connectors 35 and 37 in FIGS. 2 and 3, the connector 51 has the same upright arrangement as the connectors 47 and 49. However, the connector 53 has had its polarity reversed by being turned upside down as compared to the upright positions of the other connectors 47, 49 and 51. In this position, the ferrule 55 of the connector 53 has an end face directed to the right and ferrule 57 has an end face directed to the left. However, it may be seen in FIG. 5 that the end face of the ferrule 57 of the connector 53 is positioned for flush engagement with the end face of the ferrule 55 of the connector 51, and that the end face of the ferrule 55 of the connector 53 is positioned for flush engagement with the end face of the ferrule 57 of the connector 51. Thus, as with the CS type connectors 31, 33, 35, 37, the SN type connectors 47, 49, 51 and 53 are capable of reversing polarity while maintaining a flush engagement of angle polished end faces of their ferrules 55, 57. Co-assigned U.S. Pat. No. 10,281,668, showing an SN type connector is incorporated herein by reference in its entirety.

In one method of making the connectors 31, 33, 35, 37 or 47, 49, 51 and 53, unpolished ferrules may be inserted into the body or housing of the connector. Both ferrules (39, 41 or 55, 57) are angle polished in the same direction. One of the ferrules in each connector is turned 180° about its longitudinal axis so that the angled end face of the turned ferrule is opposite to that of the unturned ferrule. The act of rotating the ferrule to a predetermined position for purposes of achieving the best connection with the ferrule of another, mating connector may be referred to as “tuning.” It is also envisioned that the ferrules could be polished separately from their connector body/housing, and the later inserted into the body/housing in 180° opposite positions.

Modifications and variations of the disclosed embodiments are possible without departing from the scope of the invention defined in the appended claims. For example, where specific dimensions are given, it will be understood that they are exemplary only and other dimensions are possible.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. An angle polished fiber optic connector adapted for connection with another angle polished connector in two, reversed configurations, the angle polished connector comprising:
a connector body;
a first ferrule having a longitudinal axis extending lengthwise of the first ferrule, and including a first fiber, the first ferrule having a connection end face that is polished at an angle from perpendicular to the longitudinal axis of the first ferrule, the first ferrule being supported by the connector body in a first fixed rotational position about the longitudinal axis of the first ferrule;
a second ferrule having a longitudinal axis extending lengthwise of the second ferrule, and including a second fiber, the second ferrule having a connection end face that is polished at an angle from perpendicular to the longitudinal axis of the second ferrule, the second ferrule being supported by the connector body in a second fixed rotational position about the longitudinal axis of the second ferrule, the second fixed rotational position of the second ferrule being offset by 180 degrees from the first fixed rotational position of the first ferrule.

2. The angle polished fiber optic connector as set forth in claim 1 wherein the angle from perpendicular to which each of the end faces is polished is between 5° and 15°, inclusive.

3. The angle polished fiber optic connector as set forth in claim 2 wherein the angle from perpendicular to which each of the end faces is polished is about 8°

4. The angle polished fiber optic connector as set forth in claim 1 wherein the connector body includes a top, a bottom, a left side and a right side, the end face of the first ferrule being angled toward the top of the connector body and the end face of the second ferrule being angled toward the bottom of the connector body.

5. The angle polished fiber optic connector as set forth in claim 1 wherein the connector body includes a top, a bottom, a left side and a right side, the end face of the first ferrule being angled toward the left side of the connector body and the end face of the second ferrule being angled toward the right side of the connector body.

6. The angle polished fiber optic connector as set forth in claim 1 in combination with another angle polished fiber optic connector having an identical construction, the angle polished fiber optic connectors being mateable in connections of different polarity.

7. A method of making an angled polished fiber optic connector comprising the steps of polishing end faces of fiber optic ferrules at the same angle and manipulating at least one of the ferrules so that as installed in a connector body the positions of the end faces are 180 degrees opposite from each other.

8. The method as set forth in claim 7 wherein the ferrules are installed in the connector body prior to the polishing of the end faces to an angle.

9. The method as set forth in claim 8 wherein one of the ferrules is rotated about its longitudinal axis with respect to the connector body through 180 degrees.
